(19) United States
(12) Patent Application Publication
(10) Pub. No.: US 2025/0126228 A1
(43) Pub. Date: Apr. 17, 2025

(54) GENERATING AND RENDERING SCREEN TILES TAILORED TO DEPICT VIRTUAL MEETING PARTICIPANTS IN A GROUP SETTING

(71) Applicant: Google LLC, Mountain View, CA (US)

(72) Inventors: Andrey Ryabtsev, Seattle, WA (US); Rahul Garg, Sunnyvale, CA (US); Amelio Vázquez-Reina, Palo Alto, CA (US); Wonsik Kim, Menlo Park, CA (US); Robert Anderson, Bristol (GB); Weijuan Xi, Cupertino, CA (US); Desai Fan, Snohomish, WA (US); Fangda Li, Mountain View, CA (US); Chun-Ting Liu, Issaquah, WA (US)

(21) Appl. No.: 18/916,671

(22) Filed: Oct. 15, 2024

Related U.S. Application Data
(60) Provisional application No. 63/590,741, filed on Oct. 16, 2023.

(51) Int. Cl. H04N 7/15; G06V 10/26; G06V 40/10

(52) U.S. Cl. CPC H04N 7/157; G06V 10/273; G06V 40/10; G06V 2201/10

(57) ABSTRACT

A first video stream comprising a first image of a first participant of a virtual meeting, a second image of a second participant, and a third image of a third participant are received from a first client device connected to a virtual meeting platform. It is determined whether an image combining condition is satisfied. Responsive to determining that the image combining condition is satisfied with respect to the first image and the second image, a first screen tile comprising the first image and the second image is generated. A first size of the first screen tile is defined based on a number of images comprised by the first screen tile. A second screen tile comprising the third image is generated. A virtual meeting user interface comprising the first screen tile and the second screen tile is provided for presentation on a second client device connected to the virtual meeting platform.

### CROSS REFERENCE TO RELATED APPLICATION

This application claims the benefit of U.S. Patent Application No. 63/590,741, filed Oct. 16, 2023, which is incorporated herein in its entirety.

### TECHNICAL FIELD

Aspects and implementations of the present disclosure relate generally to virtual meetings and more specifically to generating and rendering screen tiles tailored to depict virtual meeting participants in a group setting.

### BACKGROUND

A platform can enable users to connect with other users through a video or an audio-based virtual meeting (e.g., a conference call, or a video conference). The platform can provide tools that allow multiple client devices to connect over a network and share each other's audio data (e.g., a voice of a user recorded via a microphone of a client device) and/or video data (e.g., a video captured by a camera of a client device, or video captured from a screen image of the client device) for efficient communication. In some instances, multiple client devices can capture video and/or audio data for a user, or a group of users (e.g., in the same meeting room), during a meeting. The video and/or audio can then be displayed in a user interface of the participating client devices. For example, the platform can display video from each client device in a separate box (commonly referred to as a tile) in the user interface.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a method comprising receiving, from a first client device connected to a virtual meeting platform, a first video stream comprising a first image of a first participant of a virtual meeting, a second image of a second participant of the virtual meeting, and a third image of a third participant of the virtual meeting. The method further comprises determining whether an image combining condition is satisfied with respect to the first image and the second image. The method further comprises, responsive to determining that the image combining condition is satisfied with respect to the first image and the second image, generating a first screen tile comprising the first image and the second image, wherein a first size of the first screen tile is defined based on a number of images comprised by the first screen tile. The method further comprises generating a second screen tile comprising the third image. The method further comprises causing a virtual meeting user interface (UI) comprising the first screen tile and the second screen tile to be provided for presentation on a second client device connected to the virtual meeting platform.

In some implementations, the image combining condition is satisfied when a distance between the first image and the second image is below a threshold distance. In some implementations, the image combining condition is satisfied when a part of the second image is present within a bounding box of the first image.

In some implementations, the method further comprises determining whether a second distance between the first image and the second image satisfies the image combining condition. In some implementations, the method further comprises, responsive to determining that the second distance between the first image and the second image does not satisfy the image combining condition, modifying the first screen tile to remove the second image and generating a third screen tile comprising the second image, wherein a second size of the first screen tile is reduced to reflect a reduced number of images comprised by the first screen tile. In some implementations, the method further comprises causing the virtual meeting UI to be modified to comprise the first screen tile, the second screen tile, and the third screen tile. In some implementations, the method further comprises determining whether a third distance between the second image and the third image satisfies the image combining condition. In some implementations, the method further comprises, responsive to determining that the third distance between the second image and the third image satisfies the image combining condition, modifying the second screen tile to include the third image, wherein a third size of the second screen tile is increased to reflect an increased number of images comprised by the second screen tile. In some implementations, the method further comprises causing the virtual meeting UI to be modified to remove the third screen tile.

In some implementations, the method further comprises detecting that the first video stream no longer includes the second image. In some implementations, the method further comprises, responsive to detecting that the first video stream no longer includes the second image, modifying the first screen tile to remove the second image, wherein a second size of the first screen tile is reduced to reflect a reduced number of images comprised by the first screen tile. In some implementations, the method further comprises modifying the second screen tile by increasing a third size of the second screen tile. In some implementations, the method further comprises causing the virtual meeting UI to be modified to include the modified first screen tile and the modified second screen tile.

In some implementations, the method further comprises detecting, within the first video stream, a fourth image of a fourth participant of the virtual meeting. In some implementations, the method further comprises determining whether an image combining condition is satisfied with respect to the fourth image and the third image. In some implementations, the method further comprises, responsive to determining that the image combining condition is satisfied with respect to the fourth image and the third image, modifying the second screen tile to include the fourth image, wherein a second size of the second screen tile is defined based on a number of images comprised by the second screen tile. In some implementations, the method further comprises modifying the first screen tile by decreasing a first size of the first screen tile. In some implementations, the method further comprises causing the virtual meeting UI to be modified to include the modified first screen tile and the modified second screen tile.

In some implementations, the first image, the second image, and the third image are detected by the first client device within a subset of frames of a third video stream acquired by a camera associated with the first client device.

In some implementations, the first video stream comprises metadata identifying a position of the first image within at least a subset of frames of the first video stream.

In some implementations, a position of the first image is stabilized within at least a subset of frames of the first video stream.

In some implementations, generating the second screen tile further comprises modifying, based on comparing a third size of the third image and a first size of the first image, a zoom level of the third image.

Another aspect of the disclosure provides a system comprising a memory and a processing device, coupled to the memory, configured to perform operations comprising receiving, from a first client device connected to a virtual meeting platform, a first video stream comprising a first image of a first participant of a virtual meeting, a second image of a second participant of the virtual meeting, and a third image of a third participant of the virtual meeting. The processing device is further configured to perform operations comprising determining whether an image combining condition is satisfied with respect to the first image and the second image. The processing device is further configured to perform operations comprising, responsive to determining that the image combining condition is satisfied with respect to the first image and the second image, generating a first screen tile comprising the first image and the second image, wherein a first size of the first screen tile is defined based on a number of images comprised by the first screen tile. The processing device is further configured to perform operations comprising generating a second screen tile comprising the third image. The processing device is further configured to perform operations comprising causing a virtual meeting user interface (UI) comprising the first screen tile and the second screen tile to be provided for presentation on a second client device connected to the virtual meeting platform.

In some implementations, the processing device is further configured to perform operations comprising determining whether a second distance between the first image and the second image satisfies the image combining condition. In some implementations, the processing device is further configured to perform operations comprising, responsive to determining that the second distance between the first image and the second image does not satisfy the image combining condition, modifying the first screen tile to remove the second image and generating a third screen tile comprising the second image, wherein a second size of the first screen tile is reduced to reflect a reduced number of images comprised by the first screen tile. In some implementations, the processing device is further configured to perform operations comprising causing the virtual meeting UI to be modified to comprise the first screen tile, the second screen tile, and the third screen tile. In some implementations, the processing device is further configured to perform operations comprising determining whether a third distance between the second image and the third image satisfies the image combining condition. In some implementations, the processing device is further configured to perform operations comprising, responsive to determining that the third distance between the second image and the third image satisfies the image combining condition, modifying the second screen tile to include the third image, wherein a third size of the second screen tile is increased to reflect an increased number of images comprised by the second screen tile. In some implementations, the processing device is further configured to perform operations comprising causing the virtual meeting UI to be modified to remove the third screen tile.

In some implementations, the processing device is further configured to perform operations comprising detecting that the first video stream no longer includes the second image. In some implementations, the processing device is further configured to perform operations comprising, responsive to detecting that the first video stream no longer includes the second image, modifying the first screen tile to remove the second image, wherein a second size of the first screen tile is reduced to reflect a reduced number of images comprised by the first screen tile. In some implementations, the processing device is further configured to perform operations comprising modifying the second screen tile by increasing a third size of the second screen tile. In some implementations, the processing device is further configured to perform operations comprising causing the virtual meeting UI to be modified to include the modified first screen tile and the modified second screen tile.

In some implementations, the processing device is further configured to perform operations comprising detecting, within the first video stream, a fourth image of fourth participant of the virtual meeting. In some implementations, the processing device is further configured to perform operations comprising determining whether an image combining condition is satisfied with respect to the fourth image and the third image. In some implementations, the processing device is further configured to perform operations comprising, responsive to determining that the image combining condition is satisfied with respect to the fourth image and the third image, modifying the second screen tile to include the fourth image, wherein a second size of the second screen tile is defined based on a number of images comprised by the second screen tile. In some implementations, the processing device is further configured to perform operations comprising modifying the first screen tile by decreasing a first size of the first screen tile. In some implementations, the processing device is further configured to perform operations comprising causing the virtual meeting UI to be modified to include the modified first screen tile and the modified second screen tile.

Another aspect of the disclosure provides a non-transitory computer readable storage medium comprising instructions that, when executed by a processing device, cause the processing device to perform operations comprising receiving, from a first client device connected to a virtual meeting platform, a first video stream comprising a first image of a first participant of a virtual meeting, a second image of a second participant of the virtual meeting, and a third image of a third participant of the virtual meeting. The instructions, when executed by the processing device, further cause the processing device to perform operations comprising determining whether an image combining condition is satisfied with respect to the first image and the second image. The instructions, when executed by the processing device, further cause the processing device to perform operations comprising, responsive to determining that the image combining condition is satisfied with respect to the first image and the second image, generating a first screen tile comprising the first image and the second image, wherein a first size of the first screen tile is defined based on a number of images comprised by the first screen tile. The instructions, when executed by the processing device, further cause the processing device to perform operations comprising generating a second screen tile comprising the third image. The instructions, when executed by the processing device, further cause the processing device to perform operations comprising causing a virtual meeting user interface (UI) comprising the first screen tile and the second screen tile to be provided for presentation on a second client device connected to the virtual meeting platform.

Another aspect of the disclosure provides a method comprising receiving, during a virtual meeting between a plurality of participants, an input video stream from a first client device associated with a subset of the plurality of participants of the virtual meeting. The method further comprises selecting a subset of frames from the input video stream, the subset of frames comprising a first frame and a second frame. The method further comprises detecting, using an artificial intelligence (AI) model, a first participant image within the first frame. The method further comprises detecting, using an artificial intelligence (AI) model, a second participant image within the second frame. The method further comprises generating, for the first frame, first metadata comprising a first bounding box indicating a first position of the first participant image within the first frame. The method further comprises generating, based on the first metadata, second metadata for the second frame, wherein generating the second metadata comprises determining whether the first participant image and the second participant image depict a first participant from the subset of participants. Generating the second metadata further comprises, responsive to determining that the first participant image and the second participant image depict the first participant, determining a difference between the first position of the first participant image within the first frame and a second position of the second participant image within the second frame. Generating the second metadata further comprises, responsive to determining that the difference between the first position and the second position exceeds a threshold difference, adding to the second metadata a modified first bounding box to reflect movement of the first participant to the second position during the virtual meeting. The method further comprises generating, during the virtual meeting, an output video stream comprising the first frame associated with the first metadata and the second frame associated with the second metadata.

In some implementations, adding the modified first bounding box to the second metadata is performed responsive to determining that a difference between a first time associated with the first frame and a second time associated with the second frame exceeds a threshold period of time.

In some implementations, a third participant image depicting a second participant of the subset of participants is detected within the first frame. In some implementations, the first metadata further comprises a second bounding box indicating a third position of the third participant image within the first frame. In some implementations, a fourth participant image is detected within the second frame. In some implementations, generating the second metadata further comprises determining whether the fourth participant image depicts the second participant or a third participant within the second frame and, responsive to determining that the fourth participant image depicts the third participant, adding, to the second metadata, a third bounding box indicating a third position of the third participant image within the second frame and a fourth bounding box indicating a fourth position of the fourth participant image within the second frame. In some implementations, a fourth participant image is detected within the second frame. In some implementations, generating the second metadata further comprises determining whether the fourth participant image depicts the second participant or a third participant within the second frame. In some implementations, generating the second metadata further comprises, responsive to determining that the fourth participant image depicts the second participant, determining whether a difference between a first time associated with the first frame and a second time associated with the second frame exceeds a threshold period of time. In some implementations, generating the second metadata further comprises, responsive to determining that the difference between the first time and the second time exceeds the threshold period of time, adding, to the second metadata, a third bounding box indicating a third position of the fourth participant image within the second frame. In some implementations, generating the output video stream further comprises modifying, based on comparing a first size of the first participant image and a second size of the third participant image, a zoom level of the third participant image.

In some implementations, selecting the subset of frames from the input video stream further comprises dropping at least a predefined number of frames between the first frame and the second frame.

In some implementations, the subset of frames selected from the input video stream corresponds to a moving time window of at least predefined duration.

Another aspect of the disclosure provides a system comprising a memory and a processing device, coupled to the memory, configured to perform operations comprising receiving, during a virtual meeting between a plurality of participants, an input video stream from a first client device associated with a subset of the plurality of participants of the virtual meeting. The processing device is further configured to perform operations comprising selecting a subset of frames from the input video stream, the subset of frames comprising a first frame and a second frame. The processing device is further configured to perform operations comprising detecting, using an artificial intelligence (AI) model, a first participant image within the first frame. The processing device is further configured to perform operations comprising detecting, using an artificial intelligence (AI) model, a second participant image within the second frame. The processing device is further configured to perform operations comprising generating, for the first frame, first metadata comprising a first bounding box indicating a first position of the first participant image within the first frame. The processing device is further configured to perform operations comprising generating, based on the first metadata, second metadata for the second frame. Generating the second metadata further causes the processing device to perform operations comprising determining whether the first participant image and the second participant image depict a first participant from the subset of participants. Generating the second metadata further causes the processing device to perform operations comprising, responsive to determining that the first participant image and the second participant image depict the first participant, determining a difference between the first position of the first participant image within the first frame and a second position of the second participant image within the second frame. Generating the second metadata further causes the processing device to perform operations comprising, responsive to determining that the difference between the first position and the second position exceeds a threshold difference, adding to the second metadata a modified first bounding box to reflect movement of the first participant to the second position during the virtual meeting. The processing device is further configured to perform operations comprising generating, during the virtual meeting, an output video stream comprising the first frame associated with the first metadata and the second frame associated with the second metadata.

In some implementations, adding the modified first bounding box to the second metadata further causes the processing to perform operations comprising determining that a difference between a first time associated with the first frame and a second time associated with the second frame exceeds a threshold period of time.

In some implementations, a fourth participant image is detected within the second frame. In some implementations, generating the second metadata further causes the processing device to perform operations comprising determining whether the fourth participant image depicts the second participant or a third participant within the second frame and, responsive to determining that the fourth participant image depicts the third participant, adding, to the second metadata, a third bounding box indicating a third position of the third participant image within the second frame and a fourth bounding box indicating a fourth position of the fourth participant image within the second frame. In some implementations, generating the second metadata further causes the processing device to perform operations comprising determining whether the fourth participant image depicts the second participant or a third participant within the second frame. In some implementations, generating the second metadata further causes the processing device to perform operations comprising, responsive to determining that the fourth participant image depicts the second participant, determining whether a difference between a first time associated with the first frame and a second time associated with the second frame exceeds a threshold period of time. In some implementations, generating the second metadata further causes the processing device to perform operations comprising, responsive to determining that the difference between the first time and the second time exceeds the threshold period of time, adding, to the second metadata, a third bounding box indicating a third position of the fourth participant image within the second frame. In some implementations, generating the output video stream further causes the processing device to perform operations comprising modifying, based on comparing a first size of the first participant image and a second size of the third participant image, a zoom level of the third participant image.

In some implementations, selecting the subset of frames from the input video stream further causes the processing device to perform operations comprising dropping at least a predefined number of frames between the first frame and the second frame.

Another aspect of the disclosure provides a non-transitory computer readable storage medium comprising instructions that, when executed by a processing device, cause the processing device to perform operations comprising receiving, during a virtual meeting between a plurality of participants, an input video stream from a first client device associated with a subset of the plurality of participants of the virtual meeting. The instructions, when executed by the processing device, further cause the processing device to perform operations comprising selecting a subset of frames from the input video stream, the subset of frames comprising a first frame and a second frame. The instructions, when executed by the processing device, further cause the processing device to perform operations comprising detecting, using an artificial intelligence (AI) model, a first participant image within the first frame. The instructions, when executed by the processing device, further cause the processing device to perform operations comprising detecting, using an artificial intelligence (AI) model, a second participant image within the second frame. The instructions, when executed by the processing device, further cause the processing device to perform operations comprising generating, for the first frame, first metadata comprising a first bounding box indicating a first position of the first participant image within the first frame. The instructions, when executed by the processing device, further cause the processing device to perform operations comprising generating, based on the first metadata, second metadata for the second frame. Generating the second metadata for the second frame further causes the processing device to perform operations comprising determining whether the first participant image and the second participant image depict a first participant from the subset of participants. Generating the second metadata for the second frame further causes the processing device to perform operations comprising, responsive to determining that the first participant image and the second participant image depict the first participant, determining a difference between the first position of the first participant image within the first frame and a second position of the second participant image within the second frame. Generating the second metadata for the second frame further causes the processing device to perform operations comprising, responsive to determining that the difference between the first position and the second position exceeds a threshold difference, adding to the second metadata a modified first bounding box to reflect movement of the first participant to the second position during the virtual meeting. The instructions, when executed by the processing device, further cause the processing device to perform operations comprising generating, during the virtual meeting, an output video stream comprising the first frame associated with the first metadata and the second frame associated with the second metadata.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2A depicts a flow diagram of an example method for processing an input video stream generated by an in-room camera, in accordance with implementations of the present disclosure.

FIG. 2B depicts a flow diagram of an example method for generating metadata for frames of an input video stream generated by an in-room camera, in accordance with implementations of the present disclosure.

FIG. 3 depicts a flow diagram of an example method for generating smart video tiles, in accordance with implementations of the present disclosure.

FIG. 4 illustrates an example virtual meeting user interface depicting virtual meeting participants, in accordance with implementations of the present disclosure.

FIGS. 5-7 illustrate example virtual meeting user interfaces depicting virtual meeting participants in a multi-tile configuration, in accordance with implementations of the present disclosure.

FIG. 8 illustrates an example virtual meeting user interface when a virtual meeting participant leaves a virtual meeting, in accordance with implementations of the present disclosure.

FIG. 9 illustrates an example virtual meeting user interface when a virtual meeting participant joins a virtual meeting, in accordance with implementations of the present disclosure.

FIG. 10 is a block diagram illustrating an example computer system, in accordance with implementations of the present disclosure.

### DETAILED DESCRIPTION

Aspects of the present disclosure are related to generating and rendering screen tiles tailored to depict virtual meeting participants in a group setting. A virtual meeting platform can allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. The platform can be used to establish a virtual meeting between multiple participants (e.g., users of a virtual meeting platform connecting via multiple client devices).

In some instances, the virtual meeting can be a hybrid meeting which combines an in-room event with a virtual online component. The in-room event can include one or more participants (referred to as “in-room participants”) of the virtual meeting physically present in a physical location (e.g., a meeting room, a venue, an office). The virtual online component can include one or more participants of the virtual meeting joining remotely (referred to as “remote participants”) via, for example, the virtual meeting platform.

When in-room participants join a meeting from a physical location (e.g., a conference room), their images may collectively appear within a single screen tile (referred to as a “tile”). Displaying the in-room participants in a single tile can make it challenging for remote participants to detect who is speaking or reacting at any given moment, leading to potential confusion and ineffective collaboration, and resulting in additional communications (e.g., via email and text messaging) and follow-up meetings needed to clarify points and/or content discussed during the virtual meeting, which can use significant computing system resources. Furthermore, participating in virtual meetings that do not provide individual recognition can be exhausting for users.

Aspects of the present disclosure address these and other challenges by generating and rendering screen tiles tailored to depict virtual meeting participants in a group setting. In some implementations, a video stream and associated metadata used to generate tailored screen tiles can be defined and/or created by a client device (e.g., a camera-equipped virtual meeting appliance or any other computing device including or connected to a camera) located in a virtual meeting room. A subset of frames of the video stream acquired by the camera associated with the client device can be selected for processing by one or more artificial intelligence (AI) models, which can detect one or more in-room participant images in each frame of the video stream. For each frame of the video stream, the client device can create metadata that defines positions of the meeting participant images within the frame (e.g., using bounding boxes that reflect positions of respective in-room participant images in the frame). The metadata may also indicate whether a change in position of an in-room participant image across multiple frames corresponds to a meeting participant moving within the room, a meeting participant swapping their place with another participant within the room, a meeting participant entering or re-entering the room, or a meeting participant leaving the room. In some implementations, the client device ensures that insignificant movements of meeting participants within the room are not reflected in the metadata to focus on stable locations of virtual meeting participants in the room with the goal of improving viewing experience for meeting participants. For example, a bounding box generated for an in-room participant image in a particular frame can be modified for a subsequent frame only if the position of the in-room participant image in the subsequent frame differs from the position in the particular frame by more than a threshold distance and/or if this difference in position lasts for longer than a threshold duration.

The client device provides, for further processing, an output video stream having frames that each include one or more in-room participant images associated with respective metadata defined as discussed above. The output video stream and the metadata (which may or may not be part of the output video stream) can be provided to a virtual meeting manager which may be hosted by a server or by one or more client devices of virtual meeting participants. The virtual meeting manager uses the in-room participant images and the metadata to define and render screen tiles tailored to depict virtual meeting participants. A screen tile may refer to a user interface (UI) element that presents one or more in-room participant images from the frames of the video stream provided by the client device. The virtual meeting manager can define tailored screen tiles by determining which in-room participant images should be combined into a single (expanded) screen tile and by assigning appropriate sizes to the resulting screen tiles. In some implementations, the virtual meeting manager determines that two or more in-room participant images should be combined into a single screen tile if these in-room participant images satisfy an image combining condition (e.g., if the distance between these images as defined by respective bounding boxes is below a threshold distance or if a portion of one of these images is present in a bounding box of another of the images).

If the virtual meeting manager subsequently determines that the above in-room participant images no longer satisfy the image combining condition, one or more new screen tiles can be added to the virtual meeting UI to individually depict images of the meeting participants that were previously depicted in the expanded screen tile. In some implementations, the virtual meeting manager also reduces the size of the expanded video frame title and assigns appropriate sizes to the other screen tiles.

In some implementations, the virtual meeting manager modifies sizes of one or more screen tiles in response to an event occurring during the virtual meeting. The event may include, for example, a meeting participant entering or re-entering the room, a meeting participant moving within the room, a meeting participant leaving the room, a meeting participant becoming a presenter or speaker. The sizes of the screen tiles can be modified based on the number of meeting participants depicted in each screen tile, the number of screen tiles to be presented at current point in time, behavior of corresponding meeting participants, etc. In some implementations, the virtual meeting manager modifies a zoom level of one or more screen tiles based on the sizes of these and/or other video frames tiles.

The tailored screen tiles can be provided for display in a virtual meeting UI to enable remote participants to clearly see each in-room participant and their non-verbal cues (e.g., demeanor, gestures, etc.) and determine which meeting participant is speaking at any given moment. Further, the sizes and/or zoom levels of the tailored screen tiles are adjusted to achieve equity and uniformity in presentation of the meeting participants (e.g., equal share of screen size, height, scale, centeredness, etc.) and/or naturalness of presentation (e.g., participants are shown exactly once, large contentful areas are not shown multiple times, etc.). Furthermore, since the tailored screen tiles are created using the video stream metadata that does not reflect insignificant movements of meeting participants within the room, stability in the presentation of the virtual meeting UI is achieved (e.g., constant participant motion is avoided). As a result, overall experience for the virtual meeting participants is improved, leading to more effective collaboration, and reduced consumption of computing system resources otherwise needed for additional communications (e.g., via email and text messaging) and follow-up meetings to clarify points and/or content discussed during the virtual meetings.

It should be noted that although aspects of the present disclosure are described with reference to a conference room, they should not be so limited, and can be used in any other space or location allowing a group setting for participating users.

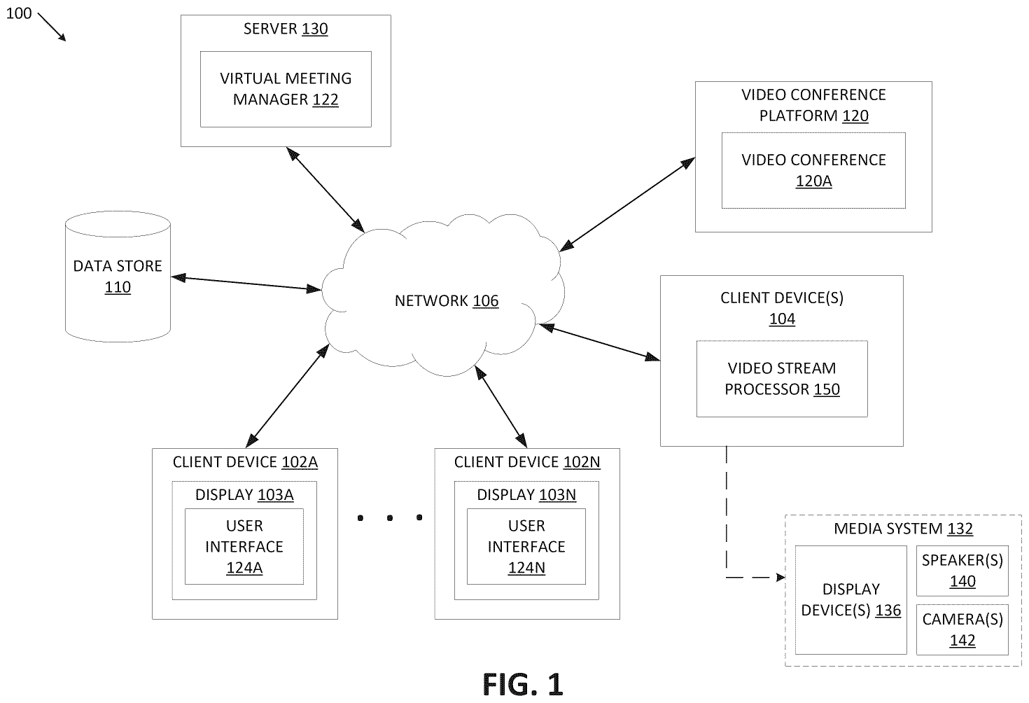

FIG. 1 illustrates an example system architecture 100, in accordance with implementations of the present disclosure. The system architecture 100 (also referred to as “system” herein) includes client devices 102A-N, one or more client devices 104, a data store 110, a video conference platform 120, and/or a server 130, each connected to a network 106.

In implementations, network 106 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. A data item can include audio data and/or video stream data, in accordance with implementations described herein. Data store 110 can be hosted by one or more storage devices, such as main memory, magnetic or optical storage-based disks, tapes or hard drives, NAS, SAN, and so forth. In some implementations, data store 110 can be a network-attached file server, while in other implementations data store 110 can be another type of persistent storage such as an object-oriented database, a relational database, and so forth, that may be hosted by video conference platform 120 or one or more different machines (e.g., the server 130) coupled to the video conference platform 120 via network 106. In some implementations, the data store 110 can store portions of audio and video streams received from the client devices 102A-N for the video conference platform 120.

Video conference platform 120 can enable users of client devices 102A-N and/or client device(s) 104 to connect with each other via a video conference (e.g., a video conference 120A). A video conference can refer to a real-time communication session such as a video conference call, also known as a video-based call or video chat, in which participants can connect with multiple additional participants in real-time and be provided with audio and video capabilities. Real-time communication refers to the ability for users to communicate (e.g., exchange information) instantly without transmission delays and/or with negligible (e.g., milliseconds or microseconds) latency. Video conference platform 120 can allow a user to join and participate in a video conference call with other users of the platform.

The client devices 102A-N can each include computing devices such as personal computers (PCs), laptops, mobile phones, smart phones, tablet computers, netbook computers, network-connected televisions, etc. In some implementations, client devices 102A-N can also be referred to as “user devices.” Each client device 102A-N can include an audiovisual component that can generate audio and video data to be streamed to video conference platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component can also include an image capture device (e.g., a camera) to capture images and generate video data (e.g., a video stream) of the captured data of the captured images.

In some implementations, video conference platform 120 is coupled, via network 106, with one or more client devices 104 that are each associated with a physical conference or meeting room. Client device(s) 104 may include or be coupled to a media system 132 that may comprise one or more display devices 136, one or more speakers 140, and/or one or more cameras 142. Display device 136 can be, for example, a smart display or a non-smart display (e.g., a display that is not itself configured to connect to network 106). Users that are physically present in the room (e.g., in-room participants) can use media system 132 rather than their own devices (e.g., client devices 102A-N) to participate in a video conference, which may include other remote users. For example, the users in the room that participate in the video conference may use the display 136 to show a slide presentation or watch slide presentations of other participants. Sound and/or camera control can similarly be performed. Similar to client devices 102A-N, client device(s) 104 can generate audio and video data to be streamed to video conference platform 120 (e.g., using one or more microphones, speakers 140 and cameras 142).

Each client device 102A-N or 104 can include a web browser and/or a client application (e.g., a mobile application, a desktop application, etc.). In some implementations, the web browser and/or the client application can present, on a display device 103A-103N of client device 102A-N, a user interface (UI) (e.g., a UI of the UIs 124A-N) for users to access video conference platform 120. For example, a user of client device 102A can join and participate in a video conference via a UI 124A presented on the display device 103A by the web browser or client application. A user can also present a document to participants of the video conference via each of the UIs 124A-N. Each of the UIs 124A-N can include multiple visual items corresponding to video streams of the client devices 102A-N provided to the server 130 for the video conference. A visual item can refer to a UI element that occupies a particular region in the UI and is dedicated to presenting a video stream from a respective client device. Such a video stream can depict, for example, a user of the respective client device while the user is participating in the video conference (e.g., speaking, presenting, listening to other participants, watching other participants, etc., at particular moments during the video conference), a physical conference or meeting room (e.g., with one or more participants present), a document or media content (e.g., video content, one or more images, etc.) being presented during the video conference, etc.

An audiovisual component of each client device can capture images and generate video data (e.g., a video stream) from the captured data of the captured images. The audiovisual component of each client device can also capture an audio signal representing speech of a user and generate audio data (e.g., an audio file or audio stream) based on the captured audio signal. In some implementations, the client devices 102A-N, 104 can transmit the generated video stream and/or audio stream directly to other client devices 102A-N, 104 participating in the video conference. In some implementations, the client devices 102A-N and/or client device(s) 104 can transmit the generated video stream and/or audio stream to a virtual meeting manager 122. In some implementations, the client devices 102A-N, 104 participating in the video conference can transmit video streams (including audio data) to server 130 which includes the virtual meeting manager 122. The server 130 can execute the virtual meeting manager 122.

The client devices 102A-N, 104 (generally referred to as “the client device”) can generate a video stream depicting one or more virtual meeting participants. In some implementations, the client device 104 can include a video stream processor 150 that receives an input video stream from camera 144, processes it as discussed herein and provides an output video stream to virtual meeting manager 122. The input video stream can depict a plurality of virtual meeting participants that are physically present in a physical location (e.g., in-room participants). The video stream processor 150 can select a subset of frames of the video stream (e.g., every N-th frame) for processing. The video stream processor 150 can analyze the subset of frames using one or more artificial intelligence (AI) models for target objection detection. The AI models can be trained to detect, in each frame of the subset of frames, one or more images each depicting an in-room participant. The detection can be performed based on features of particular types (e.g., types of facial features, etc.).

The output from the AI models can indicate the location of each detected in-room participant image within each frame of the video stream. Based on the output of the AI models, the video stream processor 150 can generate a bounding box for each detected in-room participant image to reflect the location of the in-room participant image in the frame of the video stream. The location of a bounding box can change across the sequence of frames as the in-room participant moves around the physical location in which the in-room participant is located (e.g., a conference room). The size of a bounding box can dynamically change if the in-room participant's movement causes more of the in-room participant's body to be depicted in the video stream. For example, if an in-room participant changes from a seated position to a standing position, then the bounding box of the in-room participant image that captures the in-room participant in the seated position can expand to correspond to the in-room participant image that captures the in-room participant while standing. A bounding box can change location as the in-room participant image associated with the bounding box moves (e.g., the respective in-room participant image leans forward, leans backward, stands, sits, etc.).

For each frame of the video stream, the video stream processor 150 can determine whether to modify the bounding box associated with the in-room participant image based on the output of the AI models. For example, based on receiving a first image of an in-room participant in a first frame of the video stream and a second image of an in-room participant in a second frame of the video stream, the video stream processor 150 can determine whether the first image and the second image depict the same in-room participant. Based on determining that the first image and the second image depict the same in-room participant, the video stream processor 150 can determine a distance between the bounding box associated with the in-room participant image in the first frame and the bounding box associated with the in-room participant image in the second frame. Based on determining that the distance between the bounding boxes is less than a threshold, the video stream processor 150 can maintain the bounding box associated with the in-room participant image in the second frame. Alternatively, based on determining that the distance between the bounding box in the first frame and the bounding box in the second frame exceeds the threshold, the video stream processor 150 can adjust the bounding box in the second frame to reflect the movement of the in-room participant image from the first location to the second location. The video stream processor 150 can also determine whether a difference between a first time associated with the first frame and a second time associated with the second frame exceeds a threshold period of time. Based on determining that the difference between the first time associated with the first frame and the second time associated with the second frame exceeds the threshold period of time, the video stream processor 150 can adjust the bounding box for the second frame to reflect the movement of the in-room participant image from the first location to the second location.

The video stream processor 150 can generate a second video stream with frames including in-room participant images and associated metadata comprising the bounding boxes for respective in-room participant images in each frame. In some instances, the video stream processor 150 can determine, based on the output of the AI models, that an in-room participant image depicting a first in-room participant in an earlier frame of the video stream does not have an in-room participant image depicting the first in-room participant in a current frame of the video stream (e.g., the first in-room participant steps out of the conference room, moves out of sight from the audiovisual component used to generate the video stream). As such, the video stream processor 150 may not include the bounding box associated with the in-room participant image depicting the first in-room participant in the metadata associated with the current frame of the second video stream.

In some instances, the video stream processor 150 can determine, based on the output of the AI model, that an in-room participant image depicting a first in-room participant that was not part of an earlier frame of the video stream is present in a current frame of the video stream (e.g., the first in-room participant enters the physical location, moves in view of the audiovisual component used to generate the video stream, tec.). A bounding box that indicates the location of the newly detected in-room participant image can be added to the metadata associated with the current frame of the second video stream.

The client device can transmit the second video stream and the metadata (which may or may not be part of the output media stream) to the virtual meeting manager 122, which can be hosted by server 130 (or alternatively at least some components of the virtual meeting manager 122 can be hosted by client devices 102, 104). The virtual meeting manager 122 can use the in-room participant images and the metadata to define and render screen tiles tailored to depict virtual meeting participants. The virtual meeting manager 122 can define tailored screen tiles by determining which in-room participant images should be combined into a single (expanded) screen tile and by assigning appropriate sizes (e.g., widths) to the resulting screen tiles. In some implementations, the virtual meeting manager 122 determines that two or more in-room participant images should be combined into a single screen tile if these in-room participant images satisfy an image combining condition (e.g., if the distance between these images as defined by respective bounding boxes is below a threshold distance or if a portion of one of these images is present in a bounding box of another image of these images). The threshold distance can indicate a maximum distance between bounding boxes to be depicted in a single screen tile.

If the virtual meeting manager 122 subsequently determines that the above in-room participant images no longer satisfy the image combining condition, one or more new screen tiles can be added to the expanded screen tile to individually depict images of the meeting participants that were previously depicted in the expanded screen tile. In some implementations, the virtual meeting manager 122 also reduces the size of the expanded video frame title and assigns appropriate sizes to the other screen tiles.

In some implementations, the virtual meeting manager 122 modifies sizes of one or more screen tiles in response to an event occurring during the virtual meeting. The event may represent a meeting participant entering or reentering the room, a meeting participant moving within the room, a meeting participant leaving the room, a meeting participant becoming a presenter or speaker. The sizes of the screen tiles can be modified based on the number of meeting participants depicted in each screen tile, the number of screen tiles to be presented at current point in time, behavior of corresponding meeting participants, etc. In some implementations, the virtual meeting manager 122 modifies a zoom level of one or more screen tiles based on the sizes of these screen tiles and/or the other screen tiles.

In some instances, video conference platform 120 and/or server 130 can be one or more computing devices (e.g., a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to connect with other users via a video conference. Video conference platform 120 may also include a website (e.g., a webpage) or application back-end software that may be used to enable a user to connect with other users via the video conference 120A.

It should be noted that in some other instances, the functions of server 130 or video conference platform 120 may be provided by a fewer number of machines. For example, in some instances, server 130 may be integrated into a single machine, while in other instances, server 130 may be integrated into multiple machines. In addition, in some instances, server 130 may be integrated into video conference platform 120.

In general, functions described as being performed by video conference platform 120 or server 130 can also be performed by the client devices 102A-N and/or client device(s) 104 in other implementations, if appropriate. In addition, the functionality attributed to a particular component can be performed by different or multiple components operating together. Video conference platform 120 and/or server 130 can also be accessed as a service provided to other systems or devices through appropriate application programming interfaces.

In implementations of the disclosure, a “user” may be represented as a single individual. However, other implementations of the disclosure encompass a “user” being an entity controlled by a set of users and/or an automated source. For example, a set of individual users federated as a community in a social network may be considered a “user.”

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

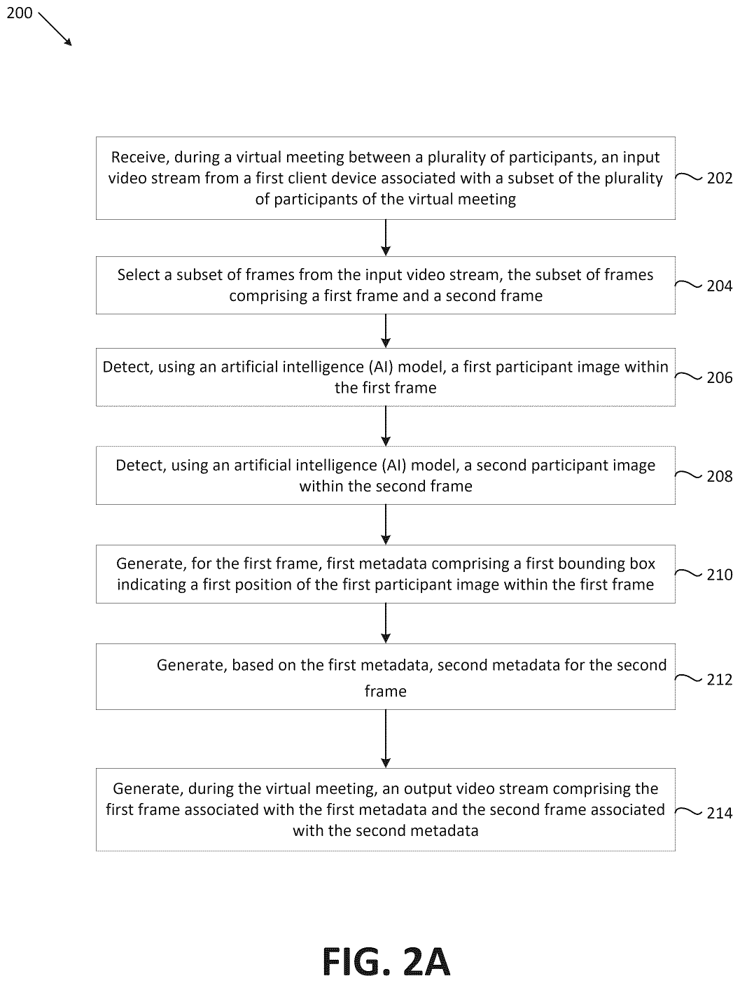

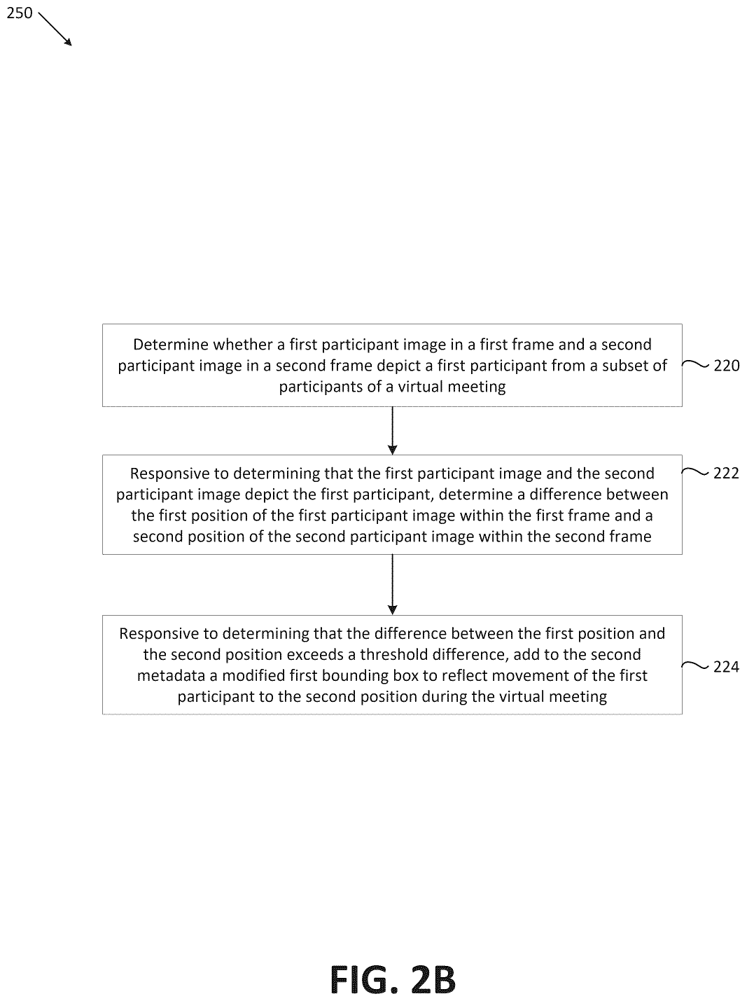

FIG. 2A depicts a flow diagram of an example method 200 for processing a video stream, in accordance with implementations of the present disclosure. Method 200 can be performed by processing logic that can include hardware (e.g., circuitry, dedicated logic, etc.), software (e.g., instructions run on a processing device), or a combination thereof. In one implementation, some or all the operations of method 200 can be performed by one or more components of system 100 of FIG. 1. In some embodiments, some or all of the operations of method 200 can be performed by video stream processor 150 which can be hosted by any of server 130 and/or client devices 102A-N, 104, as described herein.

At operation 202, the processing logic can receive, during a virtual meeting between a plurality of participants, an input video stream from a client device associated with a subset of the participants of the virtual meeting. For example, the input video stream can be received from an audiovisual component (e.g., a camera) connected to or otherwise communicating with the client device and be positioned in a physical location (e.g., a conference room). The video stream can depict in-room participants (referred to as “participants” in the discussion of FIG. 2A) that are all located in the same physical location. The plurality of participants can also include remote participants that join the virtual meeting via a virtual online component of a virtual meeting platform.

At operation 204, the processing logic can select a subset of frames from the input video stream. The subset of frames can include at least a first frame and a second frame. In some instances, the processing logic can select the subset of frames based on predetermined time intervals (e.g., N frames per second).

At operation 206, the processing logic can detect, using an AI model, a first participant image within the first frame. The processing logic can employ one or more AI models to perform target object detection in order to detect participant images in each frame of the subset of frames.

At operation 208, the processing logic can detect, using the AI model, a second participant image within the second frame.

At operation 210, the processing logic can generate, for the first frame, first metadata comprising a first bounding box indicating a first position of the first participant image within the first frame. The bounding box can be generated based on the output of the AI model that indicates the location of the detected first participant image. The processing logic can generate, for each participant, a bounding box that indicates the position of the participant in a frame of the video stream. The output of the AI model may also indicate a correspondence between participants depicted in participant images across multiple frames (e.g., a likelihood of the same participant to be depicted in the first participant image of the first frame and a second participant image of the subsequent (second) frame).

At operation 212, the processing logic can generate, based on the first metadata, second metadata for the second frame. In some implementations, the processing logic determines whether to use the first metadata of the first frame as the second metadata for the second frame or whether to create different metadata for the second frame (e.g., to include the first bounding box for the second participant image in the second metadata or to include a different bounding box for the second participant image in the second metadata). Some aspects of generating the second metadata for the second frame are discussed in more detail below in conjunction with FIG. 2B.

At operation 214, the processing logic can generate, during the virtual meeting, an output video stream comprising the first frame associated with the first metadata and the second frame associated with the second metadata. The first metadata can include the first bounding box associated with the first participant image, and the second metadata can include the first or second bounding box associated with the second participant image.

FIG. 2B depicts a flow diagram of an example method 250 for generating metadata for frames of a video stream. Method 250 can be performed by processing logic that can include hardware (e.g., circuitry, dedicated logic, etc.), software (e.g., instructions run on a processing device), or a combination thereof. In one implementation, some or all the operations of method 200 can be performed by one or more components of system 100 of FIG. 1. In some embodiments, some or all of the operations of method 250 can be performed by video stream processor 150 which can be hosted by any of server 130 and/or client devices 102A-N, 104, as described herein.

As discussed above, the processing logic can generate, for a first frame of a video stream, first metadata comprising a first bounding box indicating a first position of a first participant image within the first frame, and then generate second metadata for a second frame of the video steam based on the first metadata. For example, at block 220, the processing logic can determine whether a first participant image in the first frame and a second participant image in the second depict the same participant (e.g., first participant) from a subset of participants of the virtual meeting. In some implementations, this determination can be done based on the output of the AI model as discussed in more details above.

Further, at block 222, responsive to determining that the first participant image and the second participant image depict the first participant, the processing logic can determine a difference between the first position of the first participant image within the first frame and a second position of the second participant image within the second frame (e.g., by determining a distance between the bounding box associated with the first participant image in the first frame and the bounding box associated with the second participant image in the second frame). The processing logic can compare the distance between the first position and the second position to a threshold difference.

At block 224, responsive to determining that the difference between the first position and the second position exceeds a threshold difference, the processing logic can add to the second metadata a modified bounding box to reflect movement of the first participant to the second position during the virtual meeting.

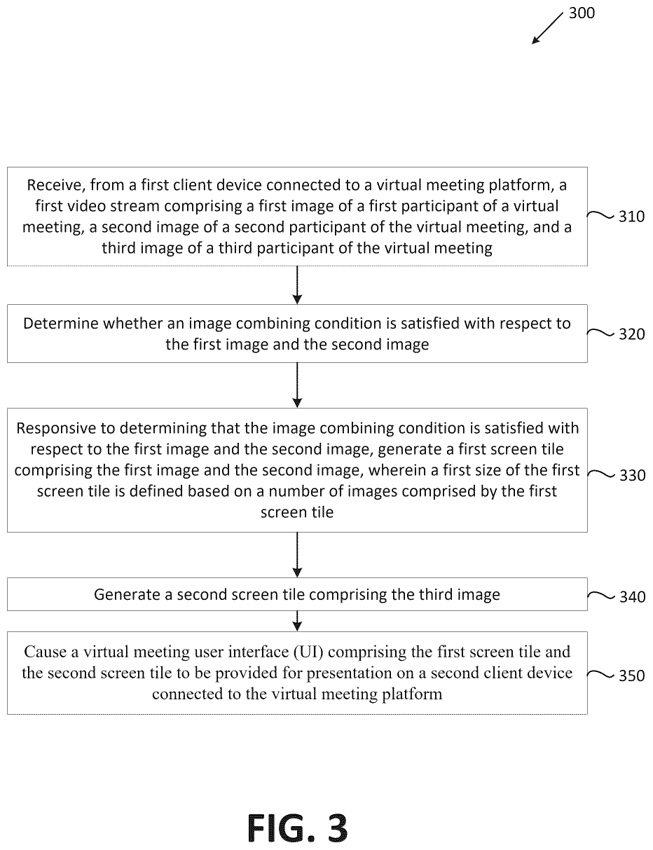

FIG. 3 depicts a flow diagram of an example method for generating smart video tiles, in accordance with implementations of the present disclosure. Method 300 can be performed by processing logic that can include hardware (e.g., circuitry, dedicated logic, etc.), software (e.g., instructions run on a processing device), or a combination thereof. In one implementation, some or all the operations of method 200 can be performed by one or more components (e.g., virtual meeting manager 122, client devices 102A-N, 104) of system 100 of FIG. 1. In some embodiments, some or all of the operations of method 200 can be performed by server 130 and/or client devices 102A-N, 104, as described herein.

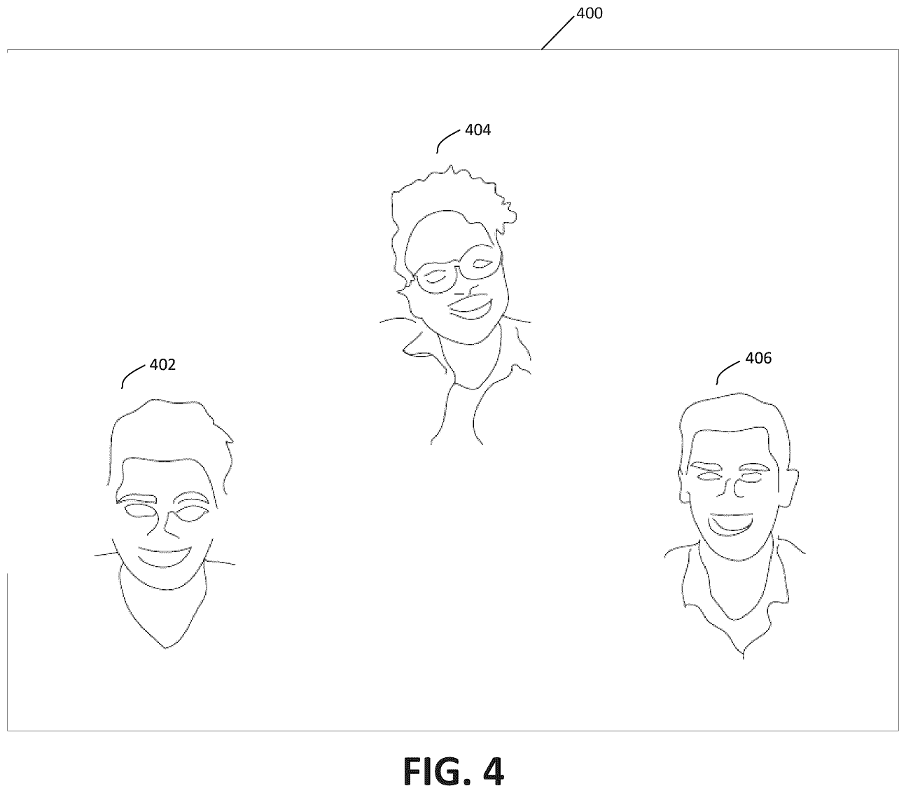

At operation 310, the processing logic can receive, from a first client device connected to a virtual meeting platform, a first video stream comprising a first image of a first participant of a virtual meeting, a second image of a second participant of the virtual meeting, and a third image of a third participant of the virtual meeting. FIG. 4 depicts an example virtual meeting user interface (UI) 400 including virtual meeting participant images, in accordance with implementations of the present disclosure. As illustrated in FIG. 4, element 402 corresponds to a first image of a first participant, element 404 corresponds to a second image of a second participant, and element 406 corresponds to a third image of a third participant of the virtual meeting.

Returning to FIG. 3, at operation 320, the processing logic can determine whether an image combining condition is satisfied with respect to the first image and the second image. In some implementations, the processing logic can determine whether the image combining condition is satisfied by determining a distance between the first image (e.g., a bounding box associated with element 402) and the second image (e.g., a bounding box associated with element 404), and comparing the distance between the first image and the second image to a threshold distance. The threshold distance can indicate a maximum distance between the first image for the first participant and the second image for the second participant to be included in the same screen tile. The processing logic can determine that the image combining condition is satisfied when the distance between the first image and the second image is less than the threshold distance. Additionally or alternatively, the processing logic can determine that the image combining condition is satisfied when at least a portion of the second image is present within the bounding box associated with the first image.

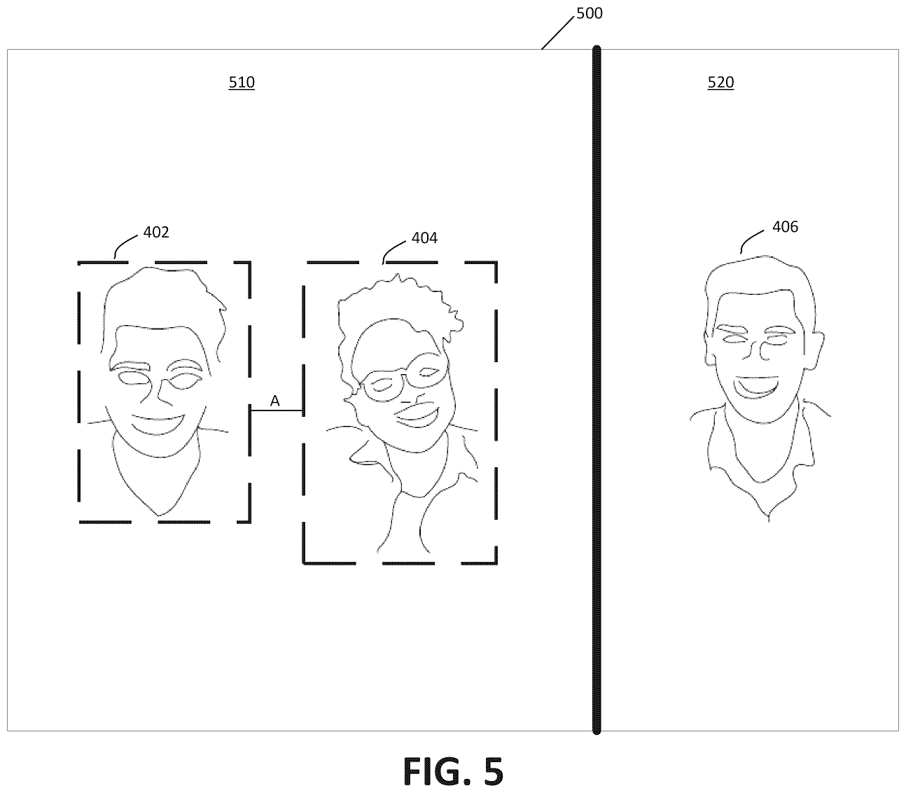

FIG. 5 illustrates an example virtual meeting user interface 500 depicting virtual meeting participants in a multi-tile configuration, in accordance with implementations of the present disclosure. The dashed lines outlining elements 402, 404 indicate images of the first participant and the second participant, respectively. The distance between the images of the first participant and the second participant is represented by distance A.

Returning to FIG. 3, at operation 330, the processing logic can, responsive to determining that the image combining condition is satisfied with respect to the first image and the second image, generate a first screen tile comprising the first image and the second image, wherein a first size (e.g., first width) of the first screen tile is defined based on a number of images comprised by the first screen tile. Referring to the discussion of FIG. 5, the processing logic can determine that the image combining condition is satisfied when distance A is less than the threshold distance. The processing logic can generate a first screen tile 510 to include the first image of the first participant and the second image of the second participant.

Returning to FIG. 3, at operation 340, the processing logic can generate a second screen tile comprising the third image. Referring to the discussion of FIG. 5, the processing logic can generate a second screen tile 520 to include the third image of the third participant. The processing logic can adjust the size of the screen tiles 510 and 520 depending on the number of images included in each. For example, since the screen tile 510 includes more images of participants than the screen tile 520, the processing large can increase the size of the screen tile 510 and decrease the size of the screen tile 520.

Returning to FIG. 3, at operation 350, the processing logic can cause a virtual meeting UI comprising the first screen tile and the second screen tile to be provided for presentation on a second client device connected to the virtual meeting platform. For example, the processing logic can create a virtual meeting UI comprising the first screen tile and the second screen tile and provide it for presentation to all participants of the virtual meeting. In another example, the processing logic can transmit the first screen tile and the second screen tile to one or more client devices of participants of the virtual meeting, which can then present the first screen tile and the second screen tile on the respective client devices.

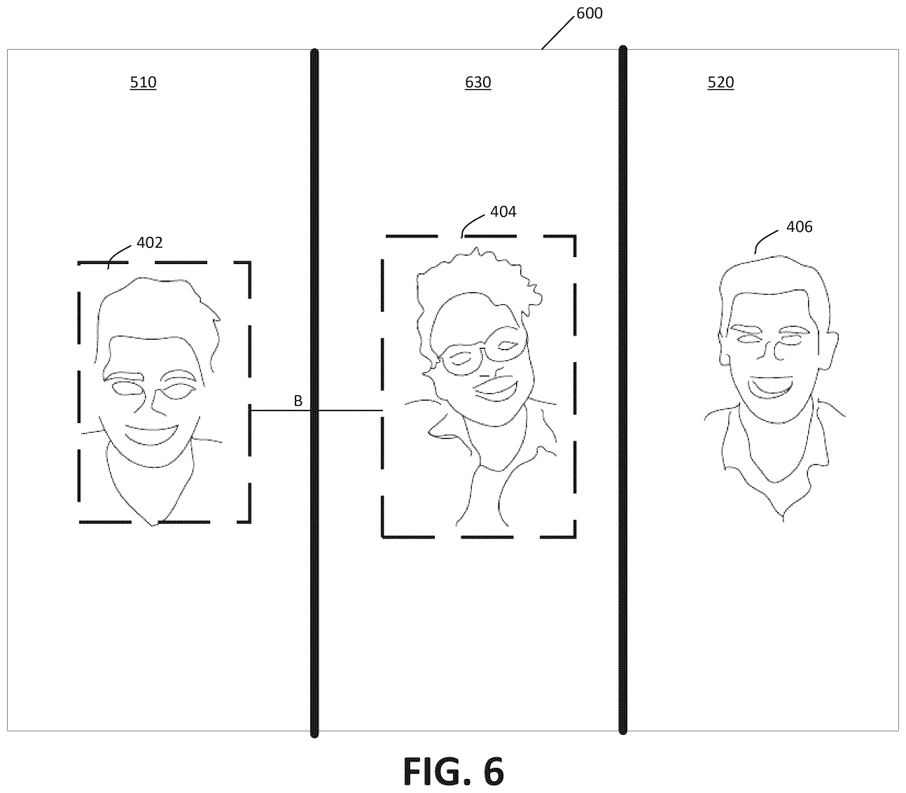

In some instances, the processing logic can determine that the distance between the first image and the second image does not satisfy the image combining condition. FIG. 6 illustrates an example virtual meeting user interface 600 depicting virtual meeting participants in a multi-tile configuration, in accordance with implementations of the present disclosure. As illustrated in FIG. 6, distance B indicates a second distance between the first image and the second image. The processing logic can determine that distance B exceeds the threshold distance. Based on determining that distance B exceeds the threshold distance, the processing logic can remove the second image from the screen tile 510 and create the screen tile 630 to include the second image of the second participant. The processing logic can adjust the size of each of the screen tiles 510, 630 and 520. In particular, the processing logic can reduce the size of the screen tile 510 to account for the fewer number of participants than it previously included and for the addition of the screen tile 630.

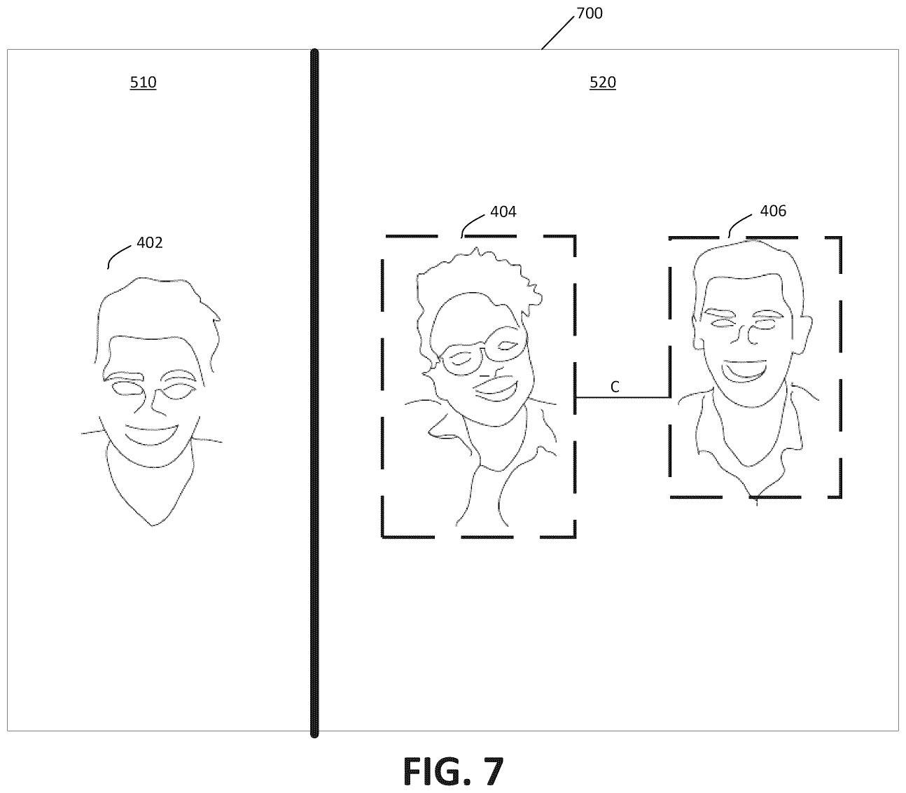

In some instances, the processing logic can determine whether a third distance between the second image and the third image satisfies the image combining condition. FIG. 7 illustrates an example virtual meeting user interface 700 depicting virtual meeting participants in a multi-tile configuration, in accordance with implementations of the present disclosure. As illustrated in FIG. 7, the processing logic can determine whether distance C between the second image and the third image is less than the threshold distance. Based on determining that the distance C between the second image and the third image is less than the threshold distance, the processing logic can remove the second image from the screen tile 510 and add the second image to the screen tile 520. The processing logic can reduce the size of the screen tile 510 since it now includes fewer participant images. The processing logic can also increase the size of the screen tile 520 since it now includes more participant images.

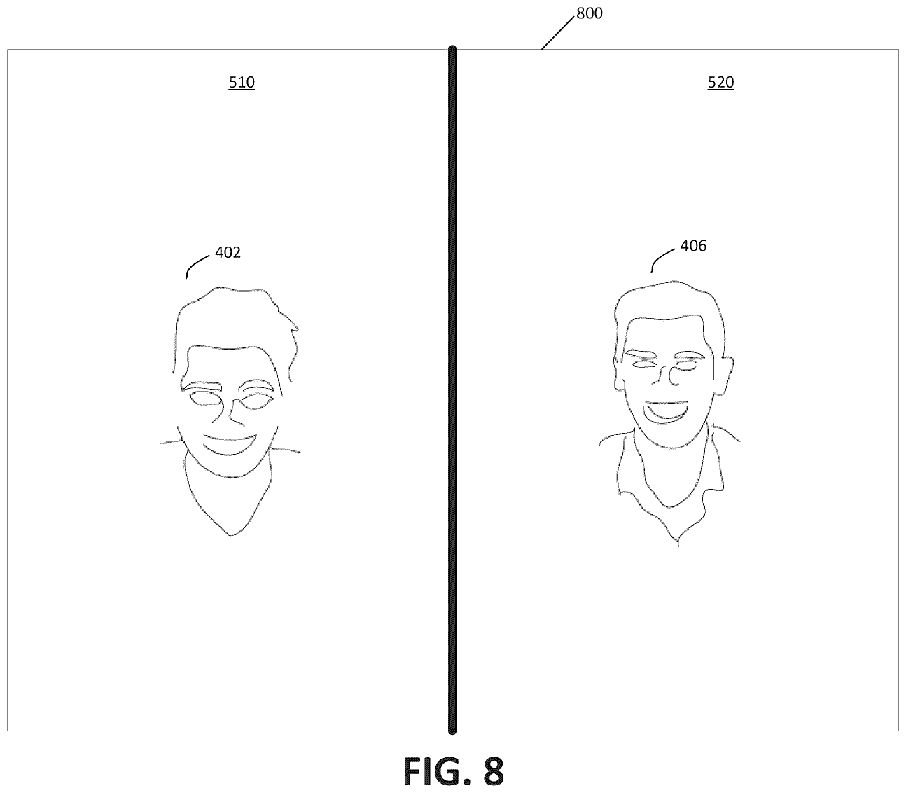

In some instances, the processing logic can determine that an image that was previously detected in a frame of the video stream is not detected in a subsequent frame of the video stream. FIG. 8 illustrates an example virtual meeting user interface 800 when a virtual meeting participant leaves the room, in accordance with implementations of the present disclosure. Based on determining that the second image of the second participant represented by element 404 is no longer detected in the video stream, the processing logic can adjust the screen tile 510 to remove the second image. The processing logic can reduce the size of the screen tile 510 to account for the fewer number of images of participants included therein. The processing logic can also increase the size of the screen tile 520 based on the adjusted size of the screen tile 510.

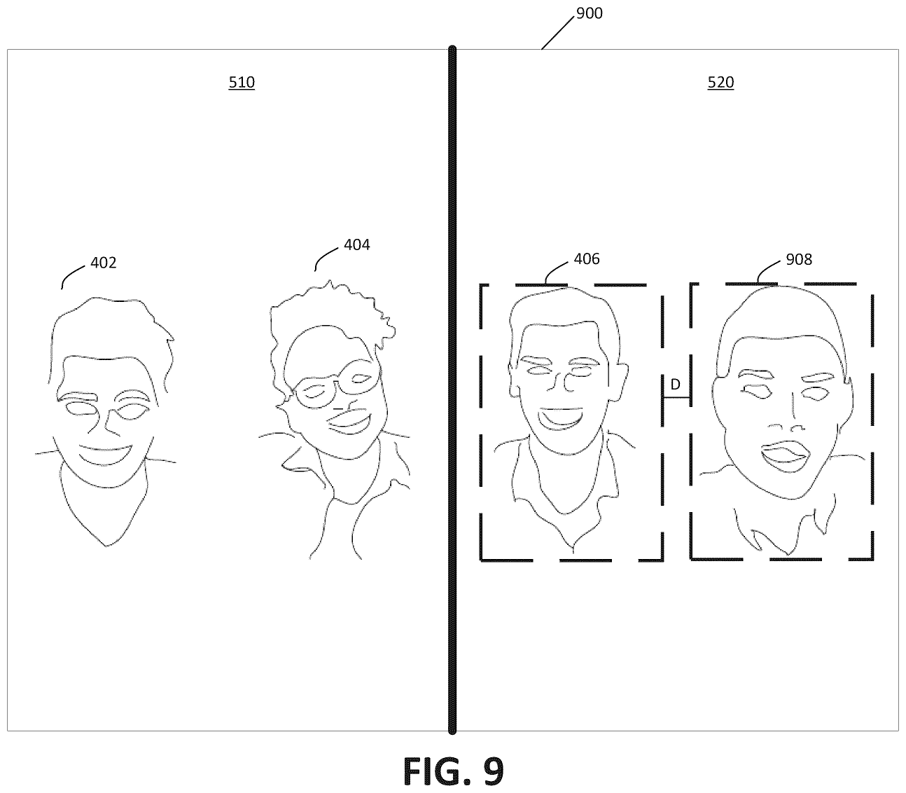

In some instances, the processing logic can determine that an image of a participant (e.g., a fourth image of a fourth participant) that was not detected in a previous frame of the video stream is detected in a current frame of the video stream. FIG. 9 illustrates an example virtual meeting user interface 900 when a virtual meeting participant enters the room, in accordance with implementations of the present disclosure. As illustrated in FIG. 9, element 908 represents the fourth image of the fourth participant detected in the video stream. The processing logic can determine whether the fourth image and any of the other images satisfy the image combining condition. The processing logic can determine that the third image and the fourth image satisfy the image combining condition based on determining that a fourth distance between the third image and the fourth image is less than the threshold distance. The processing logic can add the fourth image to the screen tile 520 that includes the third image. The processing logic can adjust the size of the screen tile 520 (e.g., enlarge the screen tile 520) to account for the additional image that is included therein. In some instances, the processing logic can detect more than four participants in the video stream. For each detected participant, the processing logic can determine whether a tile associated with a participant should be combined with or separated from one or more other tiles associated with the other participants. Based on determining that the tile associated with the participant should be combined with or separated from one or more other tiles associated with the other participants, the processing logic can adjust the size of each tile to account for the number of images of participants included therein.

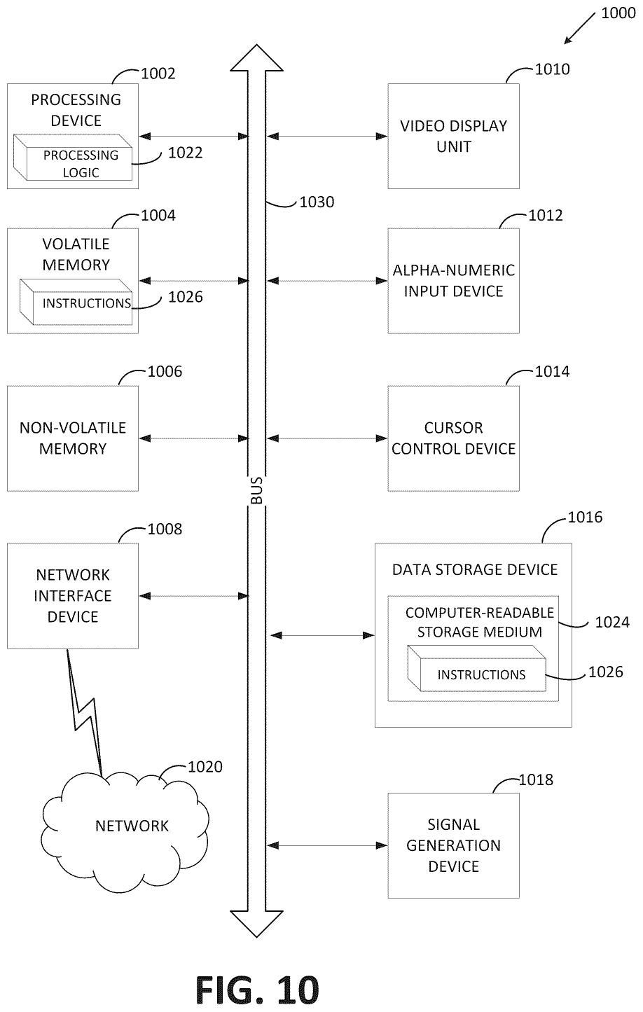

FIG. 10 is a block diagram illustrating an example computer system 1000, in accordance with implementations of the present disclosure. The computer system 1000 can correspond to video conference platform 120 and/or client devices 102A-N, 104, described with respect to FIG. 1. Computer system 1000 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processing device (processor) 1002, a volatile memory 1004 (e.g., read-only memory (ROM), flash memory, dynamic random access memory (DRAM) such as synchronous DRAM (SDRAM), double data rate (DDR SDRAM), or DRAM (RDRAM), etc.), a non-volatile memory 1006 (e.g., flash memory, static random access memory (SRAM), etc.), and a data storage device 1016, which communicate with each other via a bus 1030.

Processor (processing device) 1002 represents one or more general-purpose processing devices such as a microprocessor, central processing unit, or the like. More particularly, the processor 1002 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 can also be one or more special-purpose processing devices such as an application specific integrated circuit (ASIC), a field programmable gate array (FPGA), a digital signal processor (DSP), network processor, or the like. The processor 1002 is configured to execute processing logic 1022 for performing the operations discussed herein.

The computer system 1000 can further include a network interface device 1008. The computer system 1000 also can include a video display unit 1010 (e.g., a liquid crystal display (LCD) or a cathode ray tube (CRT)), an input device 1012 (e.g., a keyboard, and alphanumeric keyboard, a motion sensing input device, touch screen), a cursor control device 1014 (e.g., a mouse), and a signal generation device 1018 (e.g., a speaker).

The data storage device 1016 can include a non-transitory machine-readable storage medium 1024 (also computer-readable storage medium) on which is stored one or more sets of instructions 1026 embodying any one or more of the methodologies or functions described herein. The instructions can also reside, completely or at least partially, within the volatile memory 1004 and/or within the processor 1002 during execution thereof by the computer system 1000, the volatile memory 1004 and the processor 1002 also constituting machine-readable storage media. The instructions can further be transmitted or received over a network 1020 via the network interface device 1008.

In one implementation, the instructions 1026 include instructions for providing fine-grained version histories of electronic documents at a platform. While the computer-readable storage medium 1024 (machine-readable storage medium) is shown in an example implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include the collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method, comprising
receiving, from a first client device connected to a virtual meeting platform, a first video stream comprising a first image of a first participant of a virtual meeting, a second image of a second participant of the virtual meeting, and a third image of a third participant of the virtual meeting;
determining whether an image combining condition is satisfied with respect to the first image and the second image;
responsive to determining that the image combining condition is satisfied with respect to the first image and the second image, generating a first screen tile comprising the first image and the second image, wherein a first size of the first screen tile is defined based on a number of images comprised by the first screen tile;
generating a second screen tile comprising the third image; and
causing a virtual meeting user interface (UI) comprising the first screen tile and the second screen tile to be provided for presentation on a second client device connected to the virtual meeting platform.

2. The method of claim 1, wherein the image combining condition is satisfied when a distance between the first image and the second image is below a threshold distance.

3. The method of claim 1, wherein the image combining condition is satisfied when a part of the second image is present within a bounding box of the first image.

4. The method of claim 1, further comprising:
determining whether a second distance between the first image and the second image satisfies the image combining condition;
responsive to determining that the second distance between the first image and the second image does not satisfy the image combining condition, modifying the first screen tile to remove the second image and generating a third screen tile comprising the second image, wherein a second size of the first screen tile is reduced to reflect a reduced number of images comprised by the first screen tile; and
causing the virtual meeting UI to be modified to comprise the first screen tile, the second screen tile, and the third screen tile.

5. The method of claim 4, further comprising:
determining whether a third distance between the second image and the third image satisfies the image combining condition;
responsive to determining that the third distance between the second image and the third image satisfies the image combining condition, modifying the second screen tile to include the third image, wherein a third size of the second screen tile is increased to reflect an increased number of images comprised by the second screen tile; and
causing the virtual meeting UI to be modified to remove the third screen tile.

6. The method of claim 1, further comprising:
detecting that the first video stream no longer includes the second image;
responsive to detecting that the first video stream no longer includes the second image, modifying the first screen tile to remove the second image, wherein a second size of the first screen tile is reduced to reflect a reduced number of images comprised by the first screen tile;
modifying the second screen tile by increasing a third size of the second screen tile; and
causing the virtual meeting UI to be modified to include the modified first screen tile and the modified second screen tile.

7. The method of claim 1, further comprising:
detecting, within the first video stream, a fourth image of fourth participant of the virtual meeting;
determining whether an image combining condition is satisfied with respect to the fourth image and the third image;
responsive to determining that the image combining condition is satisfied with respect to the fourth image and the third image, modifying the second screen tile to include the fourth image, wherein a second size of the second screen tile is defined based on a number of images comprised by the second screen tile;
modifying the first screen tile by decreasing a first size of the first screen tile; and
causing the virtual meeting UI to be modified to include the modified first screen tile and the modified second screen tile.

8. The method of claim 1, wherein the first image, the second image, and the third image are detected by the first client device within a subset of frames of a third video stream acquired by a camera associated with the first client device.

9. The method of claim 1, wherein the first video stream comprises metadata identifying a position of the first image within at least a subset of frames of the first video stream.

10. The method of claim 1, wherein a position of the first image is stabilized within at least a subset of frames of the first video stream.

11. The method of claim 1, wherein generating the second screen tile further comprises:
modifying, based on comparing a third size of the third image and a first size of the first image, a zoom level of the third image.

12. A system comprising:
a memory; and
a processing device, coupled to the memory, configured to perform operations comprising:
receiving, from a first client device connected to a virtual meeting platform, a first video stream comprising a first image of a first participant of a virtual meeting, a second image of a second participant of the virtual meeting, and a third image of a third participant of the virtual meeting;
determining whether an image combining condition is satisfied with respect to the first image and the second image;
responsive to determining that the image combining condition is satisfied with respect to the first image and the second image, generating a first screen tile comprising the first image and the second image, wherein a first size of the first screen tile is defined based on a number of images comprised by the first screen tile;
generating a second screen tile comprising the third image; and
causing a virtual meeting user interface (UI) comprising the first screen tile and the second screen tile to be provided for presentation on a second client device connected to the virtual meeting platform.

13. The system of claim 12, wherein the image combining condition is satisfied when a distance between the first image and the second image is below a threshold distance.

14. The system of claim 12, wherein the image combining condition is satisfied when a part of the second image is present within a bounding box of the first image.

15. The system of claim 12, wherein the processing device is further configured to perform operations comprising:
determining whether a second distance between the first image and the second image satisfies the image combining condition;
responsive to determining that the second distance between the first image and the second image does not satisfy the image combining condition, modifying the first screen tile to remove the second image and generating a third screen tile comprising the second image, wherein a second size of the first screen tile is reduced to reflect a reduced number of images comprised by the first screen tile; and
causing the virtual meeting UI to be modified to comprise the first screen tile, the second screen tile, and the third screen tile.

16. The system of claim 15, wherein the processing device is further configured to perform operations comprising:
determining whether a third distance between the second image and the third image satisfies the image combining condition;
responsive to determining that the third distance between the second image and the third image satisfies the image combining condition, modifying the second screen tile to include the third image, wherein a third size of the second screen tile is increased to reflect an increased number of images comprised by the second screen tile; and
causing the virtual meeting UI to be modified to remove the third screen tile.

17. The system of claim 12, wherein the processing device is further configured to perform operations comprising:
detecting that the first video stream no longer includes the second image;
responsive to detecting that the first video stream no longer includes the second image, modifying the first screen tile to remove the second image, wherein a second size of the first screen tile is reduced to reflect a reduced number of images comprised by the first screen tile;
modifying the second screen tile by increasing a third size of the second screen tile; and
causing the virtual meeting UI to be modified to include the modified first screen tile and the modified second screen tile.

18. The system of claim 12, wherein the processing device is further configured to perform operations comprising:
detecting, within the first video stream, a fourth image of fourth participant of the virtual meeting;
determining whether an image combining condition is satisfied with respect to the fourth image and the third image;
responsive to determining that the image combining condition is satisfied with respect to the fourth image and the third image, modifying the second screen tile to include the fourth image, wherein a second size of the second screen tile is defined based on a number of images comprised by the second screen tile;
modifying the first screen tile by decreasing a first size of the first screen tile; and
causing the virtual meeting UI to be modified to include the modified first screen tile and the modified second screen tile.

19. The system of claim 12, wherein the first image, the second image, and the third image are detected by the first client device within a subset of frames of a third video stream acquired by a camera associated with the first client device.

20. A method comprising:
receiving, during a virtual meeting between a plurality of participants, an input video stream from a first client device associated with a subset of the plurality of participants of the virtual meeting;
selecting a subset of frames from the input video stream, the subset of frames comprising a first frame and a second frame;
detecting, using an artificial intelligence (AI) model, a first participant image within the first frame;
detecting, using an artificial intelligence (AI) model, a second participant image within the second frame;
generating, for the first frame, first metadata comprising a first bounding box indicating a first position of the first participant image within the first frame;
generating, based on the first metadata, second metadata for the second frame, wherein generating the second metadata comprises:
determining whether the first participant image and the second participant image depict a first participant from the subset of participants;
responsive to determining that the first participant image and the second participant image depict the first participant, determining a difference between the first position of the first participant image within the first frame and a second position of the second participant image within the second frame; and
responsive to determining that the difference between the first position and the second position exceeds a threshold difference, adding to the second metadata a modified first bounding box to reflect movement of the first participant to the second position during the virtual meeting; and
generating, during the virtual meeting, an output video stream comprising the first frame associated with the first metadata and the second frame associated with the second metadata.

21. The method of claim 20, wherein adding the modified first bounding box to the second metadata is performed responsive to determining that a difference between a first time associated with the first frame and a second time associated with the second frame exceeds a threshold period of time.

22. The method of claim 20, wherein a third participant image depicting a second participant of the subset of participants is detected within the first frame, and wherein the first metadata further comprises a second bounding box indicating a third position of the third participant image within the first frame.

23. The method of claim 22, wherein a fourth participant image is detected within the second frame, wherein generating the second metadata further comprises:
determining whether the fourth participant image depicts the second participant or a third participant within the second frame; and
responsive to determining that the fourth participant image depicts the third participant, adding, to the second metadata, a third bounding box indicating a third position of the third participant image within the second frame and a fourth bounding box indicating a fourth position of the fourth participant image within the second frame.

24. The method of claim 22, wherein a fourth participant image is detected within the second frame, wherein generating the second metadata further comprises:
determining whether the fourth participant image depicts the second participant or a third participant within the second frame;
responsive to determining that the fourth participant image depicts the second participant, determining whether a difference between a first time associated with the first frame and a second time associated with the second frame exceeds a threshold period of time; and
responsive to determining that the difference between the first time and the second time exceeds the threshold period of time, adding, to the second metadata, a third bounding box indicating a third position of the fourth participant image within the second frame.

25. The method of claim 22, wherein generating the output video stream further comprises: modifying, based on comparing a first size of the first participant image and a second size of the third participant image, a zoom level of the third participant image.

26. The method of claim 20, wherein selecting the subset of frames from the input video stream further comprises:
dropping at least a predefined number of frames between the first frame and the second frame.

27. The method of claim 20, wherein the subset of frames selected from the input video stream corresponds to a moving time window of at least predefined duration.
